(19) United States
(12) Patent Application Publication
(10) Pub. No.: US 2024/0070617 A1
(43) Pub. Date: Feb. 29, 2024

(54) SYSTEMS AND METHODS FOR FACILITATING PROACTIVE RECRUITMENT

(71) Applicant: Royal Bank of Canada, Toronto (CA)

(72) Inventors: Valerie Riabova, Toronto (CA); Kishor Gembali, Toronto (CA); Dana Little, Toronto (CA); Anthony Susevski, Toronto (CA); Eric Choi, Toronto (CA); Kaitlyn Hung, Toronto (CA)

(21) Appl. No.: 18/237,232

(22) Filed: Aug. 23, 2023

Related U.S. Application Data
(60) Provisional application No. 63/400,605, filed on Aug. 24, 2022.

(51) Int. Cl. G06Q 10/1053; G06Q 10/1093

(52) U.S. Cl. CPC G06Q 10/1053; G06Q 10/1097

(57) ABSTRACT

Methods, systems, and techniques for facilitating proactive recruitment are disclosed, comprising: receiving a user annotation of a candidate profile stored in a database, the user annotation provided by a user; based on at least the received user annotation, determining a sentiment of the user with respect to a candidate associated with the candidate profile; and when the sentiment of the user is determined to be positive, scheduling a notification to be sent to the user in response to a trigger event.

### CROSS-REFERENCE TO RELATED APPLICATIONS

This application claims priority to U.S. Provisional Patent Application No. 63/400,605, filed on Aug. 24, 2022, the entire contents of which is incorporated herein by reference for all purposes.

### TECHNICAL HELD

The present disclosure is directed to methods, systems, and techniques for facilitating proactive recruitment.

### BACKGROUND

There are several types of industry positions that require proactive recruitment of professionals. One example is in the banking industry, where branch directors proactively recruit competitive wealth advisors. Proactive recruitment differs from standard hiring practices where a job listing is posted and one or more applicants apply to the job listing and are evaluated for the position. Instead, proactive recruitment involves the sourcing of candidates, and such practices are generally a manual and time-consuming process, where recruiters often start from scratch finding candidates and researching candidate information each time they wish to proactively recruit someone. There are also disorganized and inconsistent data practices for storing and sharing information between recruiters in an organization, which can cause information to get lost and can hinder proactive recruitment. Further, there is generally a lack of communication means between recruiters in an organization, causing recruiters to recruit separately rather than in a unified manner. The foregoing deficiencies in current proactive recruitment practices cause recruiters to spend more time in lower value areas of recruiting (i.e. sourcing candidates) and less time in higher value areas of recruiting (i.e. engaging and attracting candidates). Recruiters end up being less productive due to the time spent on the low value areas of recruiting, which in turn decreases chances of acquiring the right candidate.

### SUMMARY

According to a first aspect, a method for facilitating proactive recruitment is disclosed, comprising: receiving a user annotation of a candidate profile stored in a database, the user annotation provided by a user; based on at least the received user annotation, determining a sentiment of the user with respect to a candidate associated with the candidate profile; and when the sentiment of the user is determined to be positive, scheduling a notification to be sent to the user in response to a trigger event.

In some aspects, the method further comprises: determining occurrence of the trigger event; and sending the notification to the user in response to the trigger event.

In some aspects, the trigger event is one or more of: a specified date, a predetermined time having elapsed since the user annotation, and an update to the candidate's profile.

In some aspects, the notification is one or more of: a reminder for the user to follow-up with the candidate, and a notification that the candidate profile has been updated.

In some aspects, the user adds the candidate profile to a personal repository within the database to annotate the candidate profile.

In some aspects, the database comprises a plurality of candidate profiles, and the method further comprises generating the plurality of candidate profiles by obtaining candidate information from public sources on a recurring basis, and storing the plurality of candidate profiles in the database.

In some aspects, the method further comprises: receiving a request from the user to select the candidate profile for target recruitment; and updating the candidate profile in the database to indicate that the user has selected the candidate profile for target recruitment.

In some aspects, the request from the user to select the candidate profile for target recruitment comprises adding the candidate profile to a personal repository of the user.

In some aspects, determining that the sentiment of the user with respect to the candidate is positive is based on one or more of: text indicating urgency, text referring to dates, positive words or expressions, and text comprising interesting or important features.

In some aspects, the user annotation comprises one or more of: notes about the candidate, and status updates regarding recruitment of the candidate.

In some aspects, the method further comprises determining the trigger event.

In some aspects, the trigger event is determined based on the received user annotation.

In some aspects, determining the trigger event comprises: determining if a follow-up-by date is specified in the user annotation; and when it is determined that a follow-up-by date is specified in the user annotation, setting an occurrence of the follow-up-by date as the trigger event; and when it is determined that the follow-up-by date is not specified in the user annotation, setting a passing of a predetermined period of time as the trigger event.

According to another aspect, a system for facilitating proactive recruitment is disclosed, comprising: a database storing a plurality of candidate profiles; a processor; and a non-transitory computer-readable memory having computer-executable instructions stored thereon, which when executed by the processor, configure the system to: receive a user annotation of a candidate profile stored in the database, the user annotation provided by a user; based on at least the received user annotation, determine a sentiment of the user with respect to a candidate associated with the candidate profile; and when the sentiment of the user is determined to be positive, schedule a notification to be sent to the user in response to a trigger event.

In some aspects, the computer-executable instructions, when executed by the processor, further configure the system to: determine occurrence of the trigger event; and send the notification to the user in response to the trigger event.

In some aspects, the trigger event is one or more of: a specified date, a predetermined time having elapsed since the user annotation, and an update to the candidate's profile.

In some aspects, the notification is one or more of: a reminder for the user to follow-up with the candidate, and a notification that the candidate profile has been updated.

In some aspects, the user adds the candidate profile to a personal repository within the database to annotate the candidate profile.

In some aspects, the computer-executable instructions, when executed by the processor, further configure the system to generate the plurality of candidate profiles by obtaining candidate information from public sources on a recurring basis, and store the plurality of candidate profiles in the database.

In some aspects, the computer-executable instructions, when executed by the processor, further configure the system to: receive a request from the user to select the candidate profile for target recruitment; and update the candidate profile in the database to indicate that the user has selected the candidate profile for target recruitment.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 shows a representation of a system for facilitating proactive recruitment;

FIG. 2 shows a representation of hardware components of an application server;

FIG. 3 shows a system architecture of a web application for facilitating proactive recruitment;

FIG. 4 shows a process flow diagram showing data retrieval and storage in a database;

FIG. 5 shows a process flow diagram showing how the web application interacts with the database;

FIG. 6 shows a process flow diagram showing a user interaction with the web application;

FIG. 7 shows a process flow diagram showing a machine learning inference on annotation data; and

FIG. 8 shows a method for facilitating proactive recruitment.

### DETAILED DESCRIPTION

It would be desirable to have technology that optimizes, or at least improves, recruitment efficiency of candidates to increase hiring. It would also be desirable to ensure an organized and consistent data practice for generating, storing, and sharing candidate information and recruitment progress between recruiters. Further, it would be desirable to facilitate communication between recruiters that are proactively recruiting candidates. Further still, it would be desirable to improve/optimize contact between recruiters and target candidates, and to increase the number of effective engagements with recruiters.

In accordance with the present disclosure, a central database is populated with candidate profiles generated from public sources of information on a recurring basis. A web application is provided by one or more servers that is accessible by recruiters within an organization and provides access to the central database so that recruiters can view the candidate profiles as well as filter through candidate profiles by setting recruitment criteria. Users can select candidate profiles for target recruitment, which can be seen by other recruiters so that they are aware of the recruitment efforts of different recruiters. Users may add candidates to their own repository for ease of viewing and for making notes and status updates on recruitment progress. Further, users can annotate candidate profiles with notes and/or other information relating to recruitment status/progress. A machine learning model is used to determine the sentiment of the user towards the candidate based on the annotations. When the sentiment of the recruiter is determined to be positive, the system schedules for notifications to be sent to the user in response to a trigger event, which may for example be a specified date, a pre-determined time elapsing, updates to the candidate profile, etc. Thus when the trigger event occurs, a notification is sent to the user, such as a reminder to follow-up on the recruitment process, a notification of changes to the candidate profile, etc., which facilitates engagement between the recruiter and the candidate.

Advantageously, the methods and systems for facilitating proactive recruitment disclosed herein provide a continuously updated, central storage of candidate information that recruiters can access to search for candidate profiles. Recruiters can view the recruitment progress of other recruiters within the organization, and can share information between each other. Further, the machine learning model helps to optimize the efficiency of the recruitment process by assessing recruiter sentiment and nudging recruiters to increase effective engagement with target candidates. Advantageously, the methods and systems described herein allow annotations, such as notes from a recruiter, to be used for multiple purposes such as assessing the user's sentiment about a candidate as well as scheduling further actions for the user. The use of user annotations for multiple purposes provides an efficient system and method for recruitment by reducing the required input from the user. Additionally, the systems and methods described herein provide a flexible interface to the user for providing annotations on potential candidates, which can further simplify the recruitment process for users.

The present technology may for example be used for hiring competitive wealth advisors in the financial industry. In a banking institution, branch directors are typically responsible for recruiting competitive wealth advisors, and would benefit from the systems and methods disclosed herein to mitigate inefficiencies in current recruiting practices. Further, regional directors would benefit from being able to view recruitment efforts and progress being made by the branch directors. However, while the present disclosure specifically contemplates the systems and methods for use in recruiting competitive wealth advisors, it will be appreciated that the systems and methods can be applied to other areas of proactive recruiting more generally.

In at least some embodiments herein, methods, systems, and techniques for facilitating proactive are disclosed, comprising: receiving a user annotation of a candidate profile stored in a database, the user annotation provided by a user; based on at least the received user annotation, determining a sentiment of the user with respect to a candidate associated with the candidate profile; and when the sentiment of the user is determined to be positive, scheduling a notification to be sent to the user in response to a trigger event.

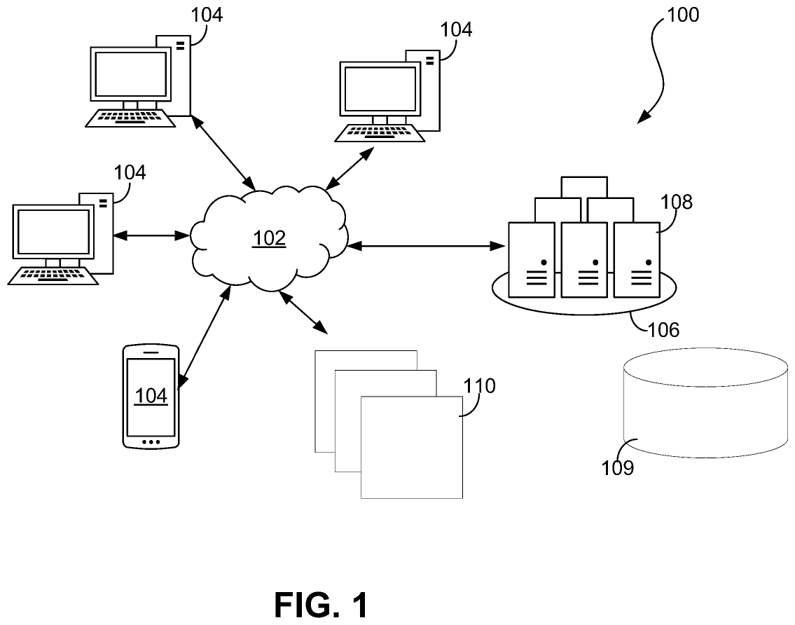

Referring now to FIG. 1, there is shown a computer network 100 that comprises an example embodiment of a system for facilitating proactive recruitment. More particularly, the computer network 100 comprises a wide area network 102 such as the Internet to which various user devices 104, data center 106, and servers hosting a plurality of webpages 110, are communicatively coupled. The data center 106 comprises a number of servers 108 networked together to collectively perform various computing functions. The servers 108 may be distributed (cloud service). In accordance with the present disclosure, the data center 106 may host a recruitment platform provided by a web application accessible on user devices 104 that have subscribed to or otherwise have access to the recruitment platform. The data center 106 further comprises a data storage 109 storing data relevant to recruitment, including candidate information obtained from webpages 110, as disclosed in more detail herein.

The user devices 104 may all belong to the same organization such as a financial institution and the data center 106 may likewise belong to the same organization. In such an implementation, the user devices 104 may access the recruitment platform via the web application provided by the servers 108 of the data center 106 via an internal webpage. However, it will be appreciated that the recruitment platform provided by the web application may be accessible by multiple organizations, with different parts of the recruitment platform and the associated recruitment data being accessible to user devices of different organizations.

In accordance with one aspect of the present disclosure, the user devices 104 may comprise different types of computer devices used by branch and/or regional directors of a banking institution, and the recruitment platform may be used to facilitate recruitment of competitive wealth advisors. Within the web application, the branch directors may access data within the data storage 109 that allows the branch and/or regional directors to search through candidate profiles of competitive wealth advisors. The candidate profiles stored in the data storage 109 may advantageously be stored by region and sorted by various recruitment criteria. The candidate profiles stored in the data storage 109 may be generated using information obtained on a recurring basis from public sources online such as the webpages 110 and stored in the data storage 109. The recruiters can select candidate profiles within the web application for target recruitment, such as by moving candidate profiles to a personal repository within the web application, where they can begin tracking the candidate recruitment/poaching progress. The candidate profile for target recruitment may be updated so that other recruiters/users can see that the candidate profile is being targeted, and therefore recruiters will know who other recruiters are targeting and not duplicate recruitment efforts. The web application may also provide a message board where different users of the platform can write posts and interact with one another to share insights and intelligence about recruitment.

In accordance with the present disclosure, the data center 106 is configured to run a machine learning model that can make predictions to facilitate recruitment processes. In one aspect, a user may annotate a candidate profile within the web application, such as by making notes regarding their recruiting status of the candidate, for example after a user has added a candidate profile for target recruitment. The machine learning model can make predictions about the sentiment of the user based on the user's annotations, and if the sentiment of the user is determined to be positive, schedules notifications to be sent to the user in response to various trigger events. A trigger event may for example be a specified date, a pre-determined time elapsing, updates to the candidate profile, etc. When a trigger event occurs, a notification may be sent to the recruiter, such as a reminder to follow-up on the recruitment process, a notification of changes to the candidate profile, etc.

The web application therefore provides an automated, centralized, and coordinated system for users/recruiters to learn, share, track, and save information on candidates for recruiting. The amount of time recruiters spend researching candidates can therefore be decreased, while also improving data collection and storage practices, as well as enhancing transparency between users and utilizing written notes by users to optimize recruiting practices. By improving inefficiencies and optimizing recruiting productivity, the recruitment platform increases the opportunity to successfully acquire more competitive candidates.

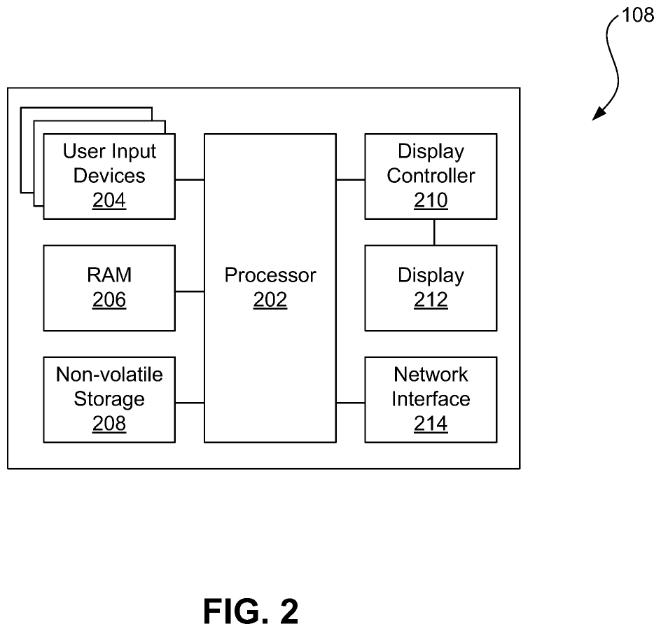

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for facilitating proactive recruitment, as disclosed in more detail herein. Additionally or alternatively, the servers 108 may collectively perform that method using distributed computing. While the system depicted in FIG. 2 is described specifically in respect of one of the servers 108, analogous versions of the system may also be used for the user devices 104.

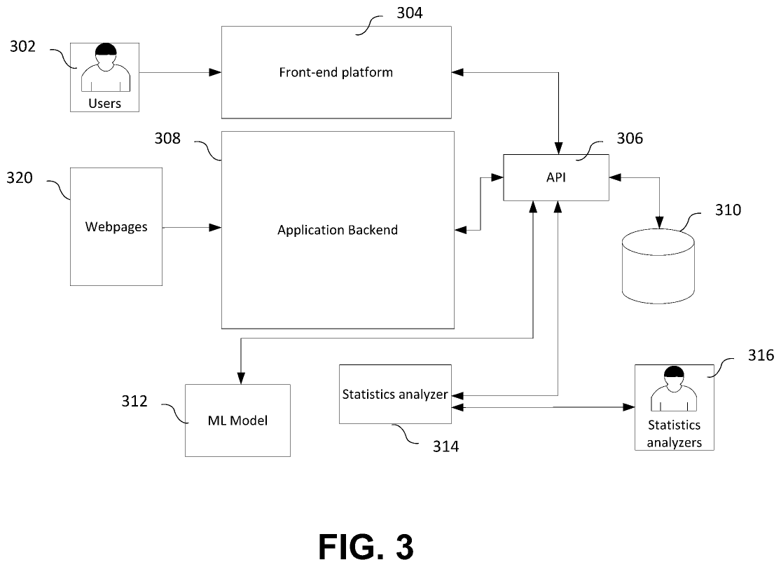

FIG. 3 shows a system architecture of a web application facilitating recruitment. As described with reference to FIG. 1, the web application may be provided by the servers 108 of data center 106 and provides a front-end platform 304 comprising a user interface for users (e.g. branch and/or regional directors 302 of a banking institution) to access the recruitment platform and perform related functionality such as adding notes and/or annotating candidate profiles, etc. The front-end platform 304 may be built using React technology, for example.

An application programming interface 306 (e.g. REST API) provides for interactions between application backend 308, database 310, machine learning module 312, statistics analyzer 314, and the front-end application 304. The API 306 may be built using Flask technology, for example.

The application backend 308 comprises script (e.g. Python script) for web scraping multiple web sources 320 (e.g. using Selenium and/or Beautiful Soup libraries) as well as API interface(s) for making API calls to APIs of web applications, and outputs the retrieved data to database 310. The database 310 may be a NoSQL database and stores the data of candidates obtained from the public sources of information, and may additionally hold user authentication information (e.g. usernames, e-mails, passwords), and stores personal repositories and annotations of users as described in more detail herein. The database 310 may for example be implemented using DynamoDB or MongoDB.

Data stored in the database 310 may be analyzed by sentiment analysis machine learning model 312 that is trained to predict the sentiment of users with respect to candidates by analyzing annotations made by users regarding certain candidate profiles. The annotations may for example be notes taken by the user, status updates regarding recruitment of the candidate, etc. A user annotation may include other information such as a length of time a user spends viewing the candidate profile, the amount of detail the user reviews of the candidate, the number of times the user views the candidate profile, etc. Based on the determined sentiment, the web application can prompt users with notifications such as reminders to follow-up on candidates that have positive sentiments associated with their candidate profiles. The machine learning model 312, which is described in more detail herein, is trained to read user annotation data from the database 310 and perform a machine learning inference through sentiment analysis, and returns a classification as to whether the sentiment of a user with respect to a candidate is positive or negative. When the sentiment of the user is positive, a notification can be scheduled for the user to follow-up with the candidate. The sentiment classification may be associated with the candidate in regards to no particular job or job posting, or may be associated with the candidate in regards to a particular job or job posting. Accordingly, the notifications may prompt the user to follow-up with the candidate to maintain contact for when specific jobs or job postings the candidate is well suited to are available, or the notifications may prompt the user to follow-up with the candidate with respect to a particular job or job positing that is actively being recruited for. The machine learning model 312 may for example use Python to support the usage of transformer models for sentiment analysis (e.g. HuggingFace), and the model may be customized/trained using analysis of annotations to improve the accuracy of predictions. The models may be updated using results of the recruitment process as well. For example, annotations of candidates that are offered a position may be used as positive class examples of positive sentiments. While it is possible to use annotations of candidates that were not offered a job as class examples of negative sentiments, doing so may be undesirable as there may be multiple candidates that would be good for a job, but only one is offered a job.

Further, data stored in the database 310 may be analyzed by a statistics analyzer 314 to generate various statistics and insights. The statistics analyzer may use Python (Matplotlib, Seaborn, numpy, pandas, etc.) to analyze the data and provide meaningful statistics. The statistics can be output to human statistic analyzers 316 such as those in recruitment, marketing, etc.

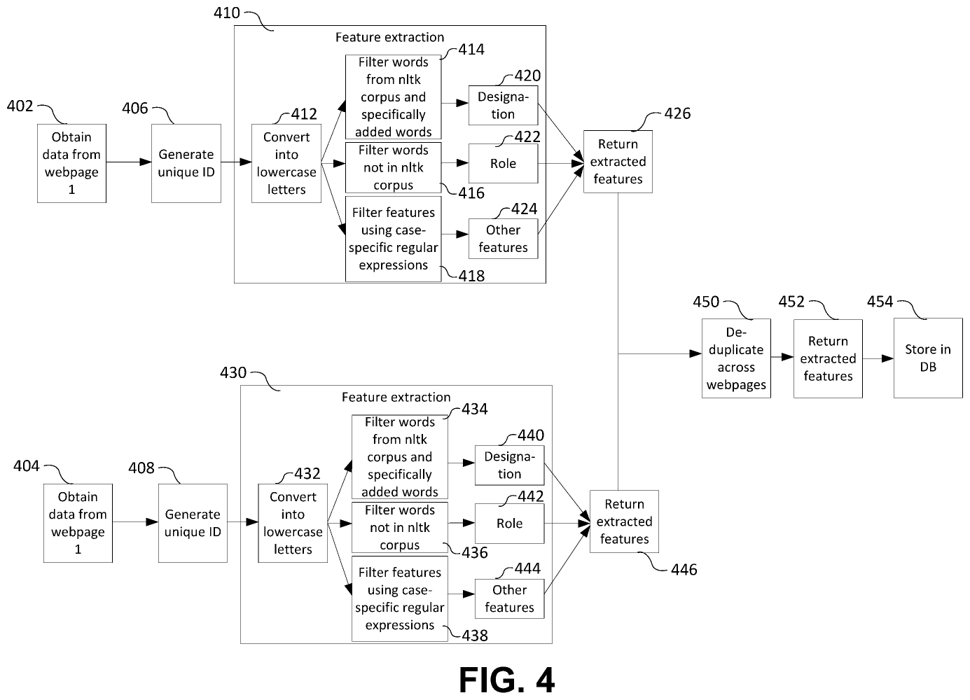

FIG. 4 shows a process flow diagram showing data retrieval and storage in a database. The process shown in FIG. 4 represents a process of web-scraping data from different web pages. However, as noted above web-scraping is not the only means by which candidate information can be obtained and the systems and methods may also be configured to make API calls to obtain data from other applications.

In FIG. 4, data is obtained from webpages 1 and 2 (402, 404). To generate candidate profiles of competitive wealth advisors, the webpages 1 and 2 may represent webpages comprising wealth advisor profiles.

A unique candidate identifier may be generated for each webpage (406, 408). The unique candidate identifier can be used for associating extracted features from the webpage with the candidate identifier. The unique candidate identifier may also be used for de-duplication purposes. It will be appreciated that different webpages may display information differently. For example, a designation of one wealth advisor may be displayed prominently, such as immediately following the wealth advisor's name, while in other cases the designation may be contained within a text paragraph. Accordingly, different scripts may be used to extract different candidate features, as described in more detail below. In general, however, each wealth advisor will have a unique e-mail address (i.e. it is not shared with any other wealth advisor) that can typically be easily identified using regular expressions. For example, a regular expression used to extract e-mails may be: “[\w.+-]+@ [\w-]+\.[\w.-]+”. The e-mail address can therefore serve as a unique identifier for generating the candidate profile, and can be used to de-duplicate names. Note that other types of unique identifiers may instead be used. For example, if an e-mail is not available but a phone number is available, the advisor's name and phone number may be concatenated to form a unique ID. A regular expression used to extract phone numbers may be: “′.?[0-9]{3}.?.?[0-9]{3}.?[0-9] {4}.*′”. If neither phone number nor email is available, the advisor's name and URL to their page on the website may be used as the unique identifier.

Feature extraction is performed (410, 430) to extract candidate information. The webpage text may be converted into lowercase letters (412, 432) to assist with the feature extraction. Again, different webpages may contain information in different manners, and therefore different scripts may be required to extract candidate information. In this example, a designation may be determined (420, 440) by filtering out words in a text block from the natural language toolkit corpus, as well as any specifically added words (e.g. names of organizations) (414, 434); a role may be determined (422, 442) by filtering out words in a text block that are not in the natural language toolkit corpus (416, 436). Other features of the candidate (e.g. location, phone number, years of experience, team size, book of business, etc.) may be determined (424, 444) using case-specific regular expressions (418, 438).

The extracted features associated with each unique candidate identifier are returned (426, 446), and de-duplicated across websites (450). Note that there should generally be no duplication of candidate information across websites, however in some instances a candidate may switch from one organization to another and their information may be present on both websites. The extracted features after de-duplication are returned (452) and stored in the database (454).

The extracted features are used to build a candidate profile for storage in the database. The candidate profile may include the candidate name, role, designation, location, e-mail address and other contact information, as well as other features such as years of experience, team size, book of business, etc. Accordingly, the candidate profiles in the database may be conveniently filtered by location, and ranked according to various recruitment criteria. In some embodiments, a candidate score may be generated for each candidate profile, which may for example be generated using a points system. An example of points awarded to a candidate profile may be as follows:
Years of experience
   0-5=0 pt
   6-20=2 pts
   21+=1 pt
a Team size
   0=Opts
   1=1 pt
   2=3 pts
   3+=4 pts
Designations
   CIMA=1
   CIWM=1
   LLQP=1
   RFP=1
   RIS=1
   CMA=2
   PFP=2
   CIM=2
   CPA=3
   FICA=3
   TEP=3
   CA=3
   CFA=3
   CFP=3

The process flow diagram shown in FIG. 4 to obtain candidate information from public sources of information may be performed on a recurring basis so that candidate profiles stored in the database are kept up-to-date.

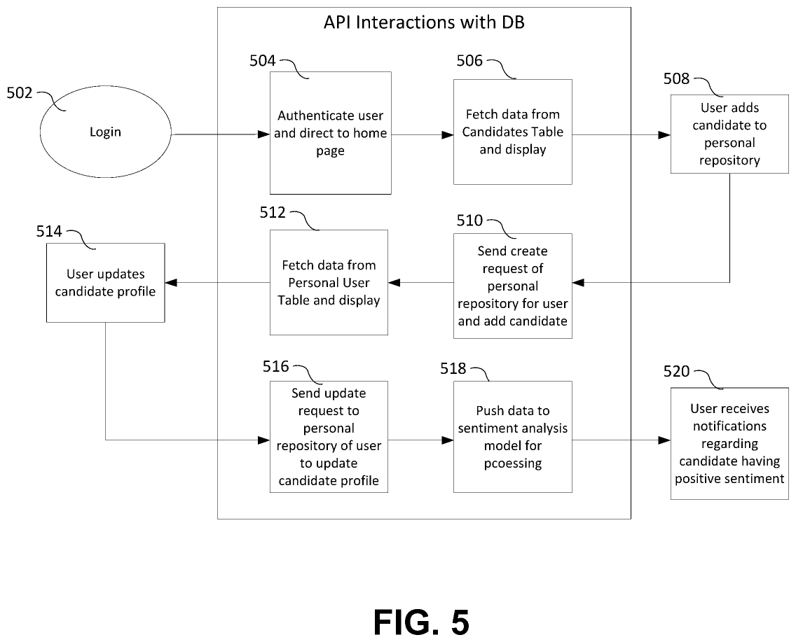

FIG. 5 shows a process flow diagram showing how the web application interacts with the database. A user logs into the web application (502), such as by using an employee or user ID and password. The user log-in is authenticated (i.e. by confirming that the employee or user ID are valid), and directed to a homepage (504). In some implementations, the homepage may display information such as a name and region of the user, the user's personal repository, a region-wide message board, and an interface to the central database. In response to the user requesting access to the central database, an API fetches candidate profiles from the central database for display (506). Note that only limited information from the candidate profile may be displayed in a first user interface, and the user may be able to click on the candidate profile to see more information. The candidate profiles may be generated with candidate information as described above, and accordingly the user can filter candidates based on specific recruitment criteria (e.g. location, organization, years of experience, team size, designations, status of candidate availability). The status of candidate availability may indicate whether any other user has selected the candidate profile for target recruitment. In some implementations, the status of candidate availability may be shown using a color-coded scheme (e.g. green, yellow, red), and may indicate which other user(s) have targeted the candidate for recruitment (thus enabling users to reach out to one another).

The user may choose to select a candidate profile for target recruitment, which may be performed by adding the candidate to the user's personal repository (508). The API sends a create request of the personal repository for the user and adds the candidate profile (510). The candidate profile in the central database may also be updated to reflect the status of the candidate's availability. The user's personal repository now contains the candidate profile, and an API may fetch data from the user's personal repository for display (512). The user may likewise filter candidates within their personal repository based on recruitment criteria.

A user may annotate the candidate profile by adding notes or other information (514). The user interface may comprise an area where users can add notes on meetings with the candidate, recruitment status updates (i.e. “met for coffee on Tuesday”, “reached out”, “in communications”, “hired”), as well as candidate personality, interests and random facts (e.g. “loves to watch baseball”). The user may also annotate the candidate profile even if they are not interested in pursuing the candidate, and such notes may be associated with the candidate profile and stored in the central database for other users to see. The API sends an update request for the user's personal repository and updates the candidate profile with the annotations (516). The API pushes the annotation data to the sentiment analysis model (518), which as further described herein is a machine learning model that performs sentiment analysis and determines if notifications should be sent to the user. The user is updated with notifications regarding the candidate when the machine learning model determines that the user sentiment towards the candidate is positive (520).

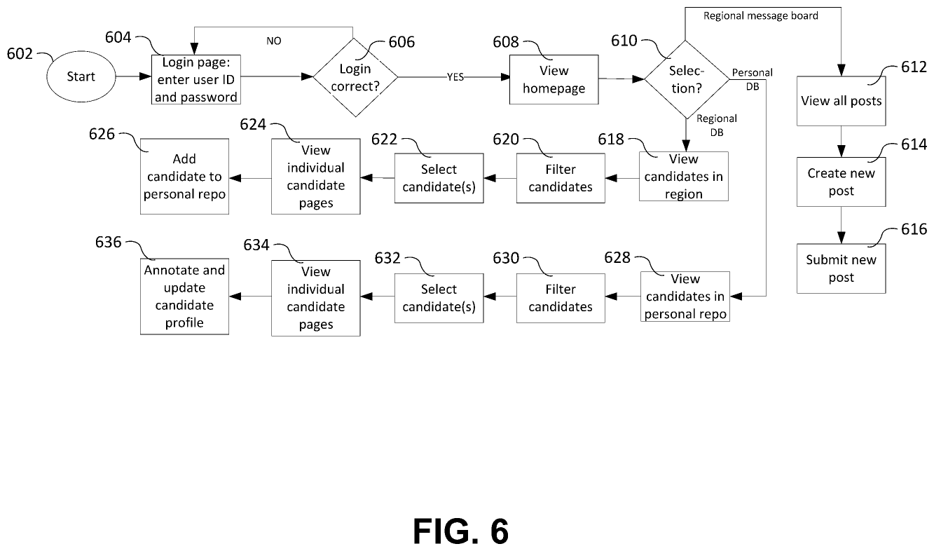

FIG. 6 shows a process flow diagram showing a user interaction with the web application. The process starts (602) and a user is presented with a login page where the user logs into the web application (604). The login information is validated (606), and when the user login information is validated, the user views homepage buttons in the user interface of the web application (608) and can make a selection to click into different areas of the application, including a regional message board, the central database, and the user's personal repository. A determination is made which button the user selects (610).

When the user clicks into the regional message board, they are able to view posts (612), create a post (614), and submit the post (616). For example, in a banking institution, posts may be made by branch directors as well as regional directors, who can make mass announcements. The message board allows branch directors and regional directors to share information about different organizations, recruitment trends, market conditions, news articles, etc.

When the user clicks into the central database (or region-wide database), they are able to view all candidate profiles (in this example, the candidates may be investment advisors) (618), filter the candidate profiles based on various recruitment criteria (e.g. location, organization, team size, designation, and/or status) (620), select one or more candidates from the list of candidates (622), view the candidate profile(s) (624) (in the central or region-wide database, the candidate profiles may not be editable), and add the candidate profile to the user's personal repository for target recruitment (626).

When the user clicks into the user's personal repository, they are able to view all personally selected candidates (628), filter the candidate profiles (e.g. by location, organization, team size, designation, and/or status) (630), select one or more candidate profile(s) (632), view the candidate profile(s) (634) (in the user's personal repository, the candidate profiles are editable), and annotate the candidate profile, which updates the candidate profile in the user's personal repository (636).

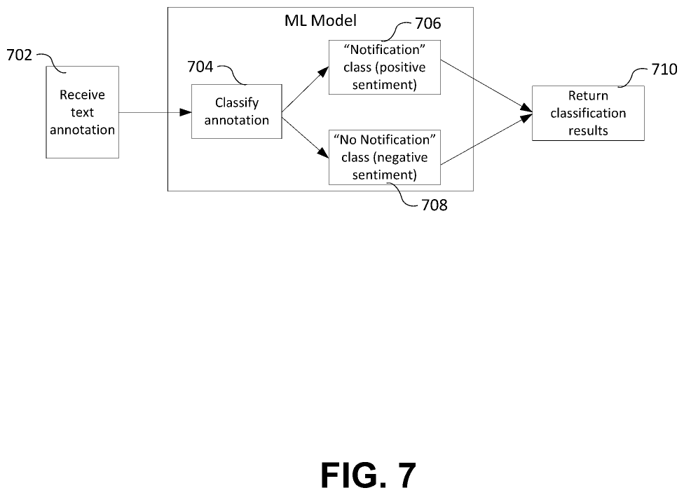

FIG. 7 shows a process flow diagram showing a machine learning inference on annotation data. In particular, and as described herein, a machine learning model may be used to perform sentiment analysis on annotations that users have made to candidate profiles.

The annotation to a candidate profile is received (702). The machine learning model classifies the annotation through sentiment analysis (704). As previously described, the machine learning module may for example use Python to support the architecture configured for reading the annotations and classifying the sentiment, which may be trained based on analysis of annotations. The model classifies the annotation in a “notification” class if the sentiment is positive (706), or in a “no notification” class if the sentiment is negative (708). It is also possible for the model to classify the annotation as not having enough information to make a determination. The results from the classification are returned (710).

Annotations associated with candidate profiles may take a variety of forms. As one example, a user of the application may write: “Great young recruit-Personal relationship. On town council. Future.” Clearly, this candidate sounds like a strong candidate, and it would be beneficial to schedule notifications to the user to follow-up. Positive sentiment may be determined by the context of the annotation, which may include looking for text indicating urgency (“schedule another call”, “follow-up”, etc.), dates (“follow-up by Monday”), and positive words/expressions (“good candidate”, “productive conversation”, “interested”). Another annotation that may be considered to be a positive sentiment is if the annotation highlights interesting or important features (e.g. “large team size”, “lots of assets under management”, etc.). Accordingly, candidate profiles that have annotations with positive sentiment are classified in a “notification” class, which will be used by the application to trigger notifications for sending to the user. Notifications and trigger events may be tailored to the context of the annotation. If an annotation indicates to follow-up by a certain date, notification(s) may be sent reminding the user to follow-up with the candidate as the date approaches. Annotations with positive sentiment that do not reference a specific date may trigger notifications after a pre-determined time has elapsed without any recruitment progress, and/or if the candidate profile changes (as determined by the recurrent updating of the candidate profiles in the database). Annotations that do not have a positive sentiment would not require notifications to be sent to the user and are classified in a “no notification” class.

It will also be appreciated that the annotations collected on candidate profiles can be used to generate various insights according to the recruitment result (i.e. whether the candidate was successfully recruited, or declined a recruitment offer). Natural language processing may be used to analyze the annotations left by users and gather insights about what may have led the candidate to their decision. Such insights would be invaluable to organizations to determine what attracts (or deters) potential candidates, and also what types of candidates should be sought for successful recruiting (e.g. based on age, book of business, etc.). Another insight that may be generated based on the annotations is an optimal frequency of contact between the recruiter and the target candidate.

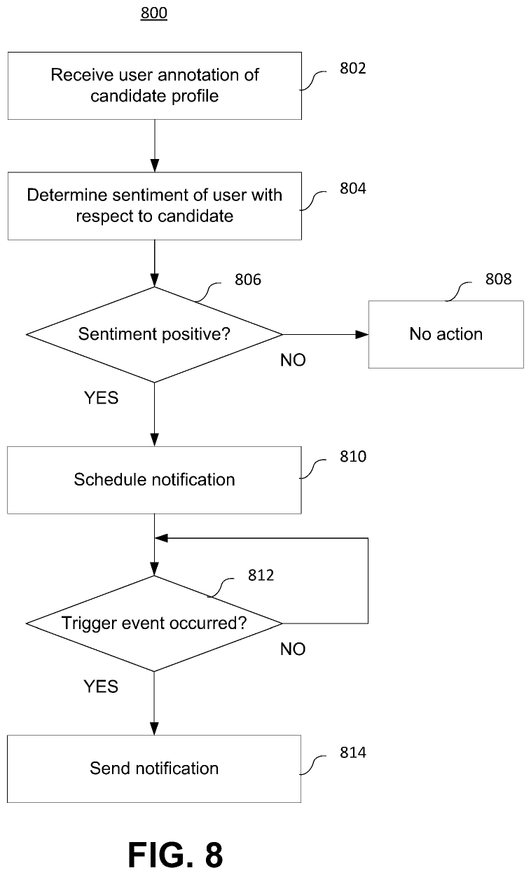

FIG. 8 shows a method 800 for facilitating proactive recruitment. The method 800 comprises receiving a user annotation of a candidate profile stored in a database (802). As previously described, the database comprises a plurality of candidate profiles generated by obtaining candidate information from public sources on a recurring basis. The user is able to access the database and filter candidate profiles in the database based on various recruitment criteria. In some aspects, the user may select the candidate profile for target recruitment, add them into their personal repository, and annotate the candidate profile with notes about the candidate, status updates regarding recruitment of the candidate, etc. The database may be updated to reflect that the candidate profile has been selected for target recruitment.

The user annotation is processed (804) to determine a sentiment of the user with respect to a candidate associated with the candidate profile. A determination is made as to whether the sentiment of the user from the user annotation with respect to the candidate profile is positive (806). If the sentiment is not positive (NO at 806), no action is taken (808). If the sentiment of the user from the user annotation is determined to be positive (YES at 806), a notification is scheduled to be sent to the user in response to a trigger event (810). As previously described, the notification may be a reminder for the user to follow-up with the candidate, a notification that the candidate profile has been updated, etc. The trigger event may also be determined, which may be based on the received user annotation. For example, the trigger event may be determined by determining if a follow-up-by date is specified in the user annotation. When it is determined that a follow-up-by date is specified in the user annotation, an occurrence of the follow-up-by date may be set as the trigger event; and when it is determined that the follow-up-by date is not specified in the user annotation, a passing of a predetermined period of time may be set as the trigger event.

A determination is made as to whether the trigger event has occurred (812). For example, the trigger event may be a certain date, a predetermined time having elapsed, an update to the candidate's profile, etc. If the trigger event has not occurred (NO at 812), the method returns and continues to determine if the trigger event has occurred (812). If the trigger event has occurred (YES at 812), the notification is sent to the user in response to the trigger event (814). The notification may be a reminder for the user to follow-up with the candidate, or a notification that the candidate profile has been updated. The notification may be sent to the user within the application platform, or externally (e.g. via e-mail).

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method for facilitating proactive recruitment, comprising:
receiving a user annotation of a candidate profile stored in a database, the user annotation provided by a user;
based on at least the received user annotation, determining a sentiment of the user with respect to a candidate associated with the candidate profile; and
when the sentiment of the user is determined to be positive, scheduling a notification to be sent to the user in response to a trigger event.

2. The method of claim 1, further comprising:
determining occurrence of the trigger event; and
sending the notification to the user in response to the trigger event.

3. The method of claim 1, wherein the trigger event is one or more of: a specified date, a predetermined time having elapsed since the user annotation, and an update to the candidate's profile.

4. The method of claim 1, wherein the notification is one or more of: a reminder for the user to follow-up with the candidate, and a notification that the candidate profile has been updated.

5. The method of claim 1, wherein the user adds the candidate profile to a personal repository within the database to annotate the candidate profile.

6. The method of claim 1, wherein the database comprises a plurality of candidate profiles, and the method further comprises generating the plurality of candidate profiles by obtaining candidate information from public sources on a recurring basis, and storing the plurality of candidate profiles in the database.

7. The method of claim 1, further comprising:
receiving a request from the user to select the candidate profile for target recruitment; and
updating the candidate profile in the database to indicate that the user has selected the candidate profile for target recruitment.

8. The method of claim 7, wherein the request from the user to select the candidate profile for target recruitment comprises adding the candidate profile to a personal repository of the user.

9. The method of claim 1, wherein determining that the sentiment of the user with respect to the candidate is positive is based on one or more of: text indicating urgency, text referring to dates, positive words or expressions, and text comprising interesting or important features.

10. The method of claim 1, wherein the user annotation comprises one or more of: notes about the candidate, and status updates regarding recruitment of the candidate.

11. The method of claim 1, further comprising determining the trigger event.

12. The method of claim 11, wherein the trigger event is determined based on the received user annotation.

13. The method of claim 12, wherein determining the trigger event comprises:
determining if a follow-up-by date is specified in the user annotation; and
when it is determined that a follow-up-by date is specified in the user annotation, setting an occurrence of the follow-up-by date as the trigger event; and
when it is determined that the follow-up-by date is not specified in the user annotation, setting a passing of a predetermined period of time as the trigger event.

14. A system for facilitating proactive recruitment, comprising:
a database storing a plurality of candidate profiles;
a processor; and
a non-transitory computer-readable memory having computer-executable instructions stored thereon, which when executed by the processor, configure the system to:
receive a user annotation of a candidate profile stored in the database, the user annotation provided by a user;
based on at least the received user annotation, determine a sentiment of the user with respect to a candidate associated with the candidate profile; and
when the sentiment of the user is determined to be positive, schedule a notification to be sent to the user in response to a trigger event.

15. The system of claim 14, wherein the computer-executable instructions, when executed by the processor, further configure the system to:
determine occurrence of the trigger event; and
send the notification to the user in response to the trigger event.

16. The system of claim 14, wherein the trigger event is one or more of: a specified date, a predetermined time having elapsed since the user annotation, and an update to the candidate's profile.

17. The system of claim 14, wherein the notification is one or more of: a reminder for the user to follow-up with the candidate, and a notification that the candidate profile has been updated.

18. The system of claim 14, wherein the user adds the candidate profile to a personal repository within the database to annotate the candidate profile.

19. The system of claim 14, wherein the computer-executable instructions, when executed by the processor, further configure the system to generate the plurality of candidate profiles by obtaining candidate information from public sources on a recurring basis, and store the plurality of candidate profiles in the database.

20. The system of claim 14, wherein the computer-executable instructions, when executed by the processor, further configure the system to:
receive a request from the user to select the candidate profile for target recruitment; and
update the candidate profile in the database to indicate that the user has selected the candidate profile for target recruitment.
